(19) United States
(12) Patent Application Publication
(10) Pub. No.: US 2007/0108039 A1
(43) Pub. Date: May 17, 2007

(54) Control of air flow for apparatus to produce reduction agents

(75) Inventors: Achim Neubauer, Sinzheim-Vormberg (DE); Norbert Breuer, Ditzingen (DE); Peter Riegger, Stuttgart (DE); Andrew Pierson, Buehl (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/599,887

(22) Filed: Nov. 14, 2006

(30) Foreign Application Priority Data
May 12, 2006 (DE) 10 2006 022 385.3
Sep. 14, 2006 (DE) 10 2006 043 099.9
Dec. 27, 2005 (DE) 10 2005 062 556.8
Nov. 14, 2005 (DE) 10 2005 054 129.1
May 9, 2006 (DE) 10 2006 021 490.0
May 17, 2006 (DE) 10 2006 022 992.4
May 11, 2006 (DE) 10 2006 021 987.2
Apr. 24, 2006 (DE) 10 2006 018 955.8
May 18, 2006 (DE) 10 2006 023 338.7
May 4, 2006 (DE) 10 2006 020 693.2

(51) Int. Cl. H05F 3/00; B01J 19/08

(52) U.S. Cl. 204/164; 422/186.04

(57) ABSTRACT

The invention concerns a device for the production of ammonia for the selective catalytic reduction of nitrogen oxides in the exhaust of an internal combustion engine with an air supply. If the air supply includes a power supply, which is independent of the power of the internal combustion engine, and which powers a compression stage for air supply, the result would be an efficient production of reduction agents even under varying operating conditions of the internal combustion engine and the addition of the reduction agent in proper amounts to the exhaust to be cleaned.

The invention concerns a device to generate ammonia for the selective catalytic reduction of nitrogen oxides in the exhaust of an internal combustion engine with an air supply.

An appropriate secondary treatment of exhaust gases is required in connection with future legal requirements regarding the emissions of nitrogen oxides. The selective catalytic reduction may be used to reduce NOx emissions (NOx reduction) of internal combustion engines, specifically diesel engines, with generally predominantly clean exhaust, i.e. rich in oxygen. This process adds a defined amount of a selectively acting reduction agent to the exhaust. This may take the form of ammonia, which is added directly in gaseous form or which is obtained from a precursor solution, such as urea, or from a urea-water solution (HWL). The disadvantage of the use of HWL is that HWL is consumed during the operations of the combustion engine. The rate of use is about 4% of the fuel consumption. The supply of urea-water solutions must therefore be diffuse, such as in gasoline/fuel filling stations. It is also disadvantageous that HWL must be carried in the vehicle.

Thus, U.S. 2004/0168905 A1 proposes to generate ammonia from nitrogen oxide obtained from open air in a gas-discharge plasma and fuel-rich fuel-air mixture in a catalyst. This uses only inputs already carried in the vehicle or obtainable from open air. A sufficient reduction of NOx emission requires that the air input into the plasma generator be tightly controlled and that the gas flow containing ammonia into the exhaust also be tightly controlled. For good exhaust cleaning, these airflows should be within +/−5% of the intended value. Given the various operating level of the internal combustion engine, the exhaust pressure may vary between 0 and 400 mbar, where the high value is obtained under full load. Furthermore, the load changes cause pressure changes in periods of less than one second. The air inflow systems of the current state of the arts cannot fulfill these requirements.

It is the objective of this invention to create an air inflow system that facilitates a sufficiently precise and fast adjustment of air inflow of an ammonia-generating device.

The objective is achieved by adding a blower for a compression step for the air inflow that is independent of the speed of the internal combustion engine. This allows for an efficient production of reduction agents under varying operating conditions of the internal combustion engine and for adding the correct amount of reduction agent to the exhaust to be cleaned.

A particularly safe operation with components that have been proven in durability and reliability proposes to use a turbine, a positive displacement pump, or a rotary pump for the compression step.

If the rotation step is powered with electricity, the control can adjust to changing operating conditions particularly quickly and the air inflow can operate independently of the internal combustion engine. An electric motor that powers the compression step can be powered by direct current from the vehicle net and may be embodied as a standard direct current motor or an electronically commutated motor. The power supply may also use pulse-width modulation. If the air input is designed to include an electronic control unit with a temperature probe and/or a pressure probe and/or a flow meter, the control unit can identify the air flow at the output of the air inflow with precision and can adjust it to the current operating status of the internal combustion engine and modify the compression status accordingly. The individual components of the electronic control unit may be linked with a CAN bus (CAN=Controller Area Network) to each other and to other components of the control system of the internal combustion engine and they may include a self-diagnosis function.

A simplified structure of the vehicle electronic system incorporates the electronic control unit into the control system of the internal combustion engine and/or into the control system of the reduction agent supply.

If a check valve and/or a pressure regulating valve and/or an air flap are incorporated into the inflow system at the output of the compression stage, it is feasible to preclude the flow of exhaust into the reduction agent generator, when the air inflow system is turned off. The use of a pressure-regulating valve permits a purely mechanical control of the air inflow, which saves the costs of an electronic control.

If the air inflow system contains a compression stage with constant output pressure, the output pressure may be set to match the maximum requirement for the output pressure, such that the control of the compression step is reduced to turning it on and off. This simplifies the control system.

The useful life of the compression stage may be extended by combining the input of the compression stage with the output of the compression stage for air input into the internal combustion engine. In many operating situations of the internal combustion engine, the output of the compression stage for air input is sufficient and the compression stage in the air inflow supply system does not need to be operated.

The invention is described in more detail in the following by reference to the embodiment examples depicted in the figures. They show:

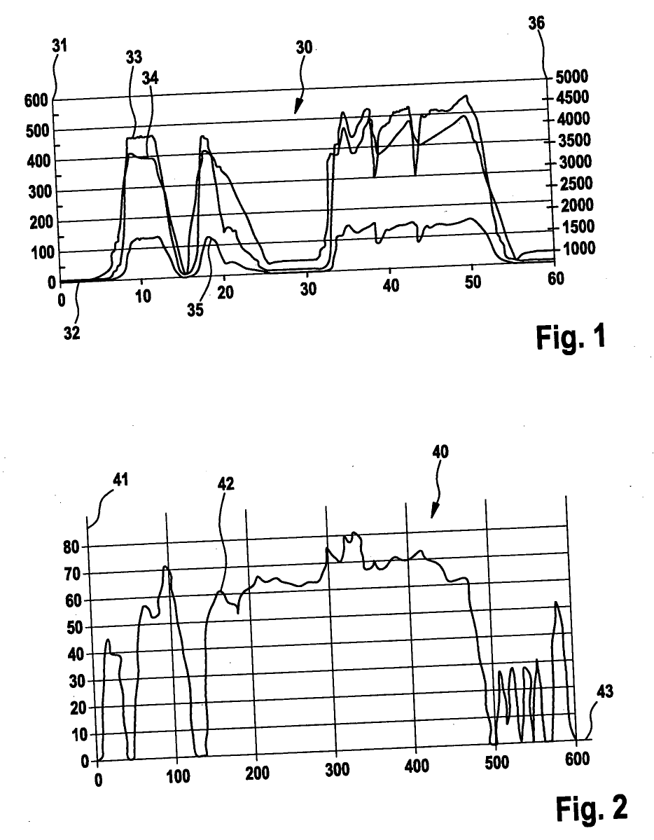

FIG. 1 a diagram of the pressure in the exhaust channel in a driving cycle,

FIG. 2 a speed diagram based on US06 Supplemental Federal Test Procedure,

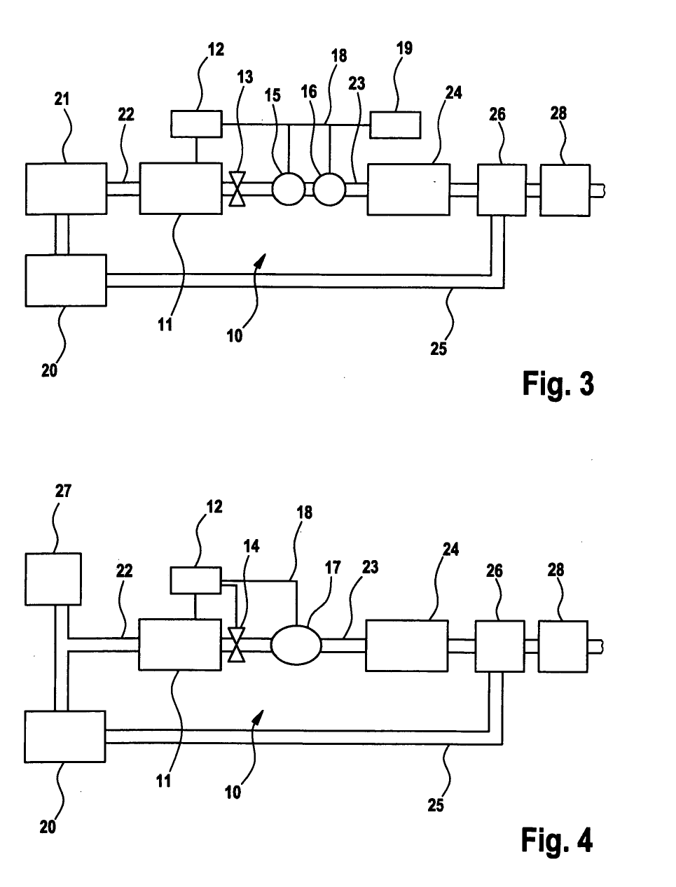

FIG. 3 an internal combustion engine with an ammonia generating system,

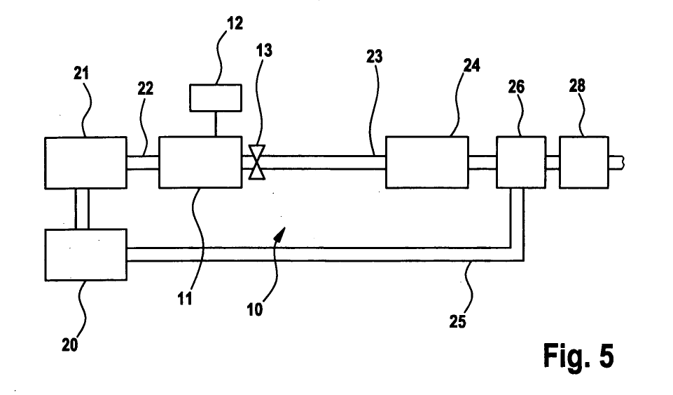

FIG. 4 the ammonia generating system with air suction behind an intercooler,

FIG. 5 the ammonia generating system with a mechanical pressure control.

FIG. 1 shows a pressure diagram 30 for the exhaust pressure in an exhaust manifold or the exhaust pipe of an internal combustion engine during an actual driving cycle. The pressure axis 31 and the first time axis 32 with second intervals show the pressure upstream of a particle filter 34 and the pressure downstream of a particle filter 35. Furthermore, the rpm axis 36 shows the motor rpm 33. The motor rpm 33 vary during the drive between 750 rpm and 4500 rpm. The pressure upstream of particle filter 34 is as much as 500 mbar higher than the ambient air pressure at high motor speeds, where the pressure may vary as much as 100 mbar within one second.

FIG. 2 shows the speed diagram for a high-load cycle 40 under US06 Supplemental Federal Test Procedure for aggressive highway driving. The speed axis 41 identifies the driving speed 42 in miles per hour by reference to a second time axis 43. There are several fast changes of speed 42, which lead to comparable variations of the operating conditions and are shown in FIG. 1 for motor rpm 33 and thus also for the pressure upstream of particle filter 34.

FIG. 3 shows an internal combustion engine 20 with an exhaust pipe 25 and an exhaust system 26 and a SCR catalyst 28 (SCR=Selective Catalytic Reduction) for the reduction of nitrogen oxides. Exhaust system 26 is connected to a generator 24 of a reduction agent, which is supplied with air by way of air supply 10. The input of air supply 10 connects an air intake 22 with an air filter 21, which also supplies air to the internal combustion engine 20. Air intake 22 feeds air into a compression stage 11, from where air is fed through check valve 13 and pressure pipe 23 to the generator 24 of a reduction agent. The compression stage may also be embodied as a piston pump powered by an electric motor or as a rotary pump. In this invention, the power supply is independent of the speed of internal combustion engine 20. Pressure pipe 23 includes a temperature probe 15 and a pressure probe 16, which are connected to control unit 12 by means of the signal feed 18. Control unit 12 also controls the compression stage 11 and is connected with a CAN Bus controller 19. During operations, control 12 controls compression stage 11 such that it generates enough airflow in pressure pipe 23 that the down-stream generator 24 of a reduction agent produces the proper amount of the reduction agent required in the current operation of the internal combustion engine to clean the exhaust. The airflow is monitored by checking the temperature with temperature probe 15 and the pressure with pressure probe 16. The check valve 13 prevents any exhaust from flowing back through exhaust system 26 into air supply 10, when the generator 24 of a reduction agent is idle.

FIG. 4 shows air supply 10, where the airflow is monitored by a flow meter 17. This flow meter is connected by means of signal feed 18 to control 12, which adjusts the speed of compression stage 11 as needed. The inflow of compression stage 11 is taken from air supply 22 from a turbocharger with charge-air cooling 27. This unit supplies air at pressures between 100 and 1300 mbar pressure. Thus, the compressed air may suffice at many operating levels of internal combustion engine 20, and control 12 may turn off power to compression stage 11. In such cases, control 12 uses an air baffle 14 to modify the pressure in pressure pipe 23.

FIG. 5 shows an embodiment of air supply 10, where control unit 12 merely turns compression stage 11 on and off, but does not modify the pressure value. The pressure is adjusted mechanically by check valve 13, which is designed for an opening pressure close to the maximum system pressure. This balances pressure variations. An alternative embodiment designs the compression stage such that its output pressure in pressure pipe 23 is close to the maximum system pressure, which would eliminate the need for an electronic component of control 12 as well as a pressure-related function of check valve 13.

1. A device for the production of ammonia for selective catalytic reduction of nitrogen oxides in an exhaust of an internal combustion engine with an air supply, wherein the device includes a power supply in the air supply, which is independent of power of the internal combustion engine, and which powers a compression stage for the air supply.

2. The device according to claim 1, wherein the compression stage is embodied as a turbine, a positive displacement pump, or a rotary pump.

3. The device according to claim 1, further including an electric power source for the compression stage.

4. The device according to claim 1, further including a temperature probe, a pressure probe, or a flow meter included in an electronic control unit in the air supply.

5. The device according to claim 4, wherein the electronic control unit is embodied as a component of a control of the internal combustion engine or a component of a control of a reduction agent supply.

6. The device according to claim 1, further including a check valve, a pressure controller, or an air baffle at an output of the compression stage in the air supply.

7. The device according to claim 6, having a design-specific constant output pressure in the compression stage in the air supply.

8. The device according to claim 1, wherein an input of the compression stage is connected to an output of the compression stage for the air supply of the internal combustion engine.
